(19) United States
(12) Patent Application Publication
(10) Pub. No.: US 2024/0062325 A1
(43) Pub. Date: Feb. 22, 2024

(54) DEVICE AND METHOD FOR CONTROLLING VEHICLE

(71) Applicants: Hyundai Motor Company, Seoul (KR); Kia Corporation, Seoul (KR)

(72) Inventors: Yim Ju Kang, Seoul (KR); Hoon Lee, Gunpo (KR)

(21) Appl. No.: 18/127,442

(22) Filed: Mar. 28, 2023

(30) Foreign Application Priority Data
Aug. 18, 2022 (KR) 10-2022-0103582

(51) Int. Cl. G06Q 50/30; G06V 20/59; G06V 40/16; G06T 7/70; G06V 20/58; G06T 7/20; G06Q 20/40

(52) U.S. Cl. CPC G06Q 50/30; G06V 20/59; G06V 40/172; G06T 7/70; G06V 20/58; G06T 7/20; G06Q 20/40; G06T 2207/30196; G06T 2207/30252; G06T 2207/30268

(57) ABSTRACT

A device for controlling a vehicle includes a sensor configured to obtain a face of a passenger and a position of the passenger, storage configured to store information on a plurality of passengers, and a processor that determines, when a passenger closest to the vehicle is obtained based on the position of the passenger, whether to approve boarding of the obtained passenger based on the information on the plurality of passengers stored in advance, and controls a boarding approval indication or a boarding disapproval indication to be output based on whether the boarding is approved.

### CROSS-REFERENCE TO RELATED APPLICATION

This application claims, under 35 U.S.C. § 119(a), the benefit of priority to Korean Patent Application No. 10-2022-0103582, filed in the Korean Intellectual Property Office on Aug. 18, 2022, the entire contents of which are incorporated herein by reference.

### BACKGROUND

### 1. Technical Field

The present disclosure relates to a device and a method for controlling a vehicle.

### 2. Background

Recently, development of a technology of an autonomous driving mobility such as a robo-taxi and a robo-shuttle that transports a passenger to a destination using an autonomous vehicle is in progress.

The robo-shuttle may allow a plurality of passengers to board and alight (unboard and/or de-plane) from the robo-shuttle at a preset stop from a departure point to the destination, or to board and alight from the robo-shuttle at a location desired by a user. A technology capable of more safely transporting the passengers to the destination must be secured for such autonomous driving mobility to be distributed. In particular, it is required to develop a technology that may periodically identify the number of passengers and provide a convenient payment method during the boarding and the alighting of the passengers to prevent overload.

### SUMMARY

The present disclosure has been made to address the above-mentioned problems occurring in the prior art while advantages achieved by the prior art are maintained intact.

An aspect of the present disclosure provides a device and a method for controlling a vehicle that may periodically identify the number of passengers and provide a convenient payment method during boarding and alighting of the passengers to prevent overload of a high-occupancy autonomous vehicle.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a device for controlling a vehicle includes a sensor for obtaining unique passenger data from a plurality of potential passengers of a vehicle, the data including facial information of each potential passenger and a position of each potential passenger, a memory storage for storing, in advance of a boarding of the vehicle process, unique passenger information associated with the plurality of potential passengers, and a processor that determines, whether to approve boarding of a respective passenger having a position closest to the vehicle based on the unique passenger information stored in the memory storage, and controls, either one of: a boarding approval indication or a boarding disapproval indication to be output based on whether the boarding of the respective passenger is approved.

In one implementation, the processor may obtain the facial information of the respective passenger from the sensor, and determine that the boarding of the respective passenger is approved based on a comparison of the obtained facial information of the respective passenger and the unique passenger information stored in the memory storage.

In one implementation, unique passenger information associated with the plurality of potential passengers includes unique passenger card tagging information and the processor may obtain passenger card tagging information associated with the plurality of potential passengers, and determine that the boarding of the passenger providing the passenger card tagging information is approved if the passenger card tagging information associated with the plurality of passengers matches the unique passenger card tagging information stored in the memory storage.

In one implementation, the processor may transmit an image of the obtained facial information of the respective passenger and/or the passenger card tagging information e associated with the plurality of passengers to a server, receive a passenger boarding approval message from the server based on the transmitted image and/or the transmitted passenger card tagging information, and determine that the boarding of the respective passenger is approved based on the passenger boarding approval message received from the server.

In one implementation, the processor may request a server to receive payment for a boarding fare if the unique passenger information of the respective passenger is determined based on unique passenger information associated with the plurality of potential passengers, receive a payment approval message from the server if payment for the boarding fare is approved by the server, and determine that the boarding of the passenger is approved based on the payment approval message from the server.

In one implementation, the processor may receive a payment approval message from a server if payment of a boarding fare is approved by the server, and determine that the boarding of the passenger is approved if the payment approval message is received from the server.

In one implementation, the device may further include a terminal capable of recognizing a passenger card of the passenger.

In one implementation, the terminal is configured to move from the inside of the vehicle to the outside of the vehicle when a door of the vehicle is opened. In another implementation, the terminal is integrally connected with the vehicle.

In one implementation, the processor may obtain unique passenger data associated with a first passenger closest to the terminal and obtain unique passenger data associated with the remaining passengers of the plurality of potential passengers based on a proximity to the first passenger.

In one implementation, the processor may determine that boarding of the remaining passengers of the plurality of potential passengers is approved.

In one implementation, the processor may output a respective boarding approval indication for each passenger until the boarding of the boarding of the remaining passengers is completed.

In one implementation, the processor may learn the unique passenger information with artificial intelligence and generate a learned model, and determine unique passenger information associated with each potential passenger based on the learned model.

In one implementation, the processor may track a movement of a moving passenger inside of the vehicle by matching unique passenger information associated with the moving passenger, determine that the moving passenger has alighted from the vehicle when the passenger moves from the inside of the vehicle to outside of the vehicle, and perform alighting processing by matching the moving passenger who has alighted from the vehicle with the unique passenger information associated with the moving passenger.

According to another aspect of the present disclosure, a device for controlling a vehicle includes a sensor for obtaining unique passenger data from a plurality of potential passengers of a vehicle, the data including facial information of each potential passenger and a position of each potential passenger, a memory storage for storing, in advance of a boarding of the vehicle process, unique passenger information associated with the plurality of potential passengers, and a processor configured to determine whether to approve alighting of a respective passenger based on the unique passenger information stored in the memory storage, and control either one of: an alighting approval indication or an alighting disapproval indication to be output based on whether the alighting of the respective passenger is approved.

In one implementation, the processor may obtain the facial information of the respective passenger from the sensor, and determine that the alighting of the passenger is approved based on a comparison of the obtained facial information of the respective passenger and the unique passenger information stored in the memory storage.

In one implementation, unique passenger information associated with the plurality of potential passengers comprises unique passenger card tagging information; and the processor may obtain passenger card tagging information associated with the plurality of potential passengers, and determine that alighting of the passenger providing the passenger card tagging information is approved if the passenger card tagging information associated with the plurality of potential passengers matches the unique passenger card tagging information stored in the memory storage.

In one implementation, the processor may transmit an image of the facial information of the respective passenger and/or the passenger card tagging information associated with the plurality of potential passengers to a server, receive a passenger alighting approval message from the server based on the transmitted image and/or the transmitted passenger card tagging information, and determine that the alighting of the respective passenger and/or the passenger providing the passenger card tagging information is approved based on the passenger alighting approval message received from the server.

In one implementation, the processor may request a server to receive payment for an alighting fare if the unique passenger information of the respective passenger is determined based on unique passenger information associated with the plurality of potential passengers, receive a payment approval message from the server if payment of the alighting fare is approved by the server, and determine that the alighting of the passenger is approved based on the payment approval message received from the server.

In one implementation, the processor may receive a payment approval message from a server if payment of an alighting fare is approved by the server and the alighting of the respective passenger is approved based on the comparison of the obtained facial information of the respective passenger and the unique passenger information stored in the memory storage, and determine that the alighting of the passenger is approved if the payment approval message is received from the server.

According to another aspect of the present disclosure, a method for controlling boarding and alighting of a vehicle includes obtaining unique passenger data from a plurality of potential passengers of a vehicle, the data including facial information of each potential passenger and/or a position of each potential passenger, storing, in advance of a boarding process and/or an alighting process of the vehicle, unique passenger information associated with the plurality of potential passengers, determining whether to approve boarding or alighting of a respective passenger based on the unique passenger information stored in the memory storage, and controlling either one of: a boarding approval indication or a boarding disapproval indication to be output based on whether boarding of the respective passenger is approved, and controlling either one of: an alighting approval indication or an alighting disapproval indication to be output based on whether alighting of the respective passenger is approved.

### BRIEF DESCRIPTION OF THE DRAWINGS

The above and other objects, features and advantages of the present disclosure will be more apparent from the following detailed description taken in conjunction with the accompanying drawings:

FIG. 1 is a diagram showing a configuration of a vehicle control device according to an embodiment of the present disclosure;

FIG. 2 is a diagram showing a sensing region of a sensor according to an embodiment of the present disclosure;

FIG. 3 is a diagram schematically showing a terminal according to an embodiment of the present disclosure;

FIGS. 4 to 8 are diagrams schematically showing an operation of a vehicle control device according to an embodiment of the present disclosure during boarding of a passenger;

FIG. 9 is a diagram showing a configuration of a server according to an embodiment of the present disclosure;

FIGS. 10 to 19 are flowcharts showing a vehicle control method according to an embodiment of the present disclosure; and

FIG. 20 is a diagram illustrating a configuration of a computing system executing a method according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure.

In describing the components of the embodiment according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

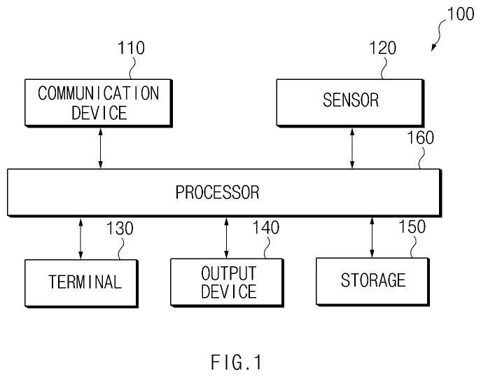

FIG. 1 is a diagram showing a configuration of a vehicle control device according to an embodiment of the present disclosure.

As shown in FIG. 1, a vehicle control device 100 may include a communication device 110, a sensor 120, a terminal 130, an output device 140, storage 150, and a processor 160, and may be mounted in a vehicle.

The communication device 110 may communicate with a server 200 in various wireless communication schemes such as a Wi-Fi, a WiBro, a global system for mobile communication (GSM), a code division multiple access (CDMA), a wideband code division multiple access (WCDMA), a universal mobile telecommunication system (UMTS), a time division multiple access (TDMA), a long term evolution (LTE), and the like.

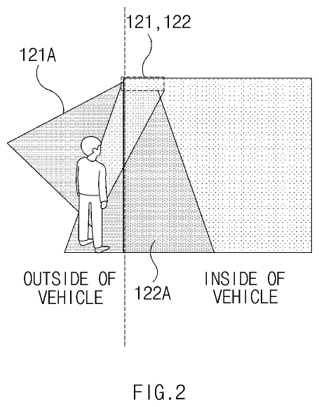

The sensor 120 may obtain a region around a vehicle door. According to an embodiment, the sensor 120 may include a first sensor 121 that obtains a face of a passenger to obtain a passenger face image and a distance from the vehicle to the passenger, and a second sensor 122 that obtains a position of the passenger. A more detailed description will be made with reference to FIG. 2.

FIG. 2 is a diagram showing a sensing region of a sensor according to an embodiment of the present disclosure.

As shown in FIG. 2, according to the embodiment, the first sensor 121 may include an image sensor included in a stereo camera and an image sensor included in a monocular camera, and may be disposed above the vehicle door and may sense a first sensing region 121A to obtain the passenger face image. The first sensor 121 may obtain a color of passenger's hair, an accessory worn by the passenger, an upper garment color, and the like. The first sensor 121 (the stereo camera) may obtain the distance to the passenger positioned in the first sensing region 121A, and may obtain position information of the passenger based on the distance.

In addition, the second sensor 122 may include a lidar or an infrared sensor, and may obtain the position information of the passenger (position information of a head). The one or more second sensors 122 may be disposed above the vehicle door or an upper portion of an interior of the vehicle to obtain information on whether the passenger has boarded the vehicle, information on whether the passenger is seated inside the vehicle, and information on a movement inside the vehicle. To this end, the second sensor 122 may sense a second sensing region 122A and an entire region inside the vehicle. In addition, the second sensor 122 may include the image sensor in the monocular camera to obtain the head of the passenger, thereby obtaining a top view image.

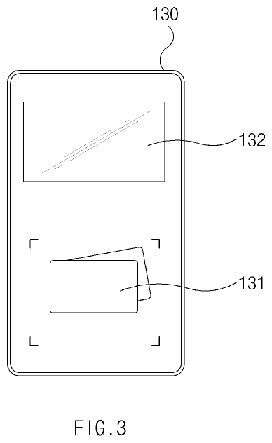

The terminal 130 may recognize a passenger card (an identification card or a credit card (a transportation card)) of the passenger. When recognizing the passenger card (the identification card or the credit card (the transportation card)) of the passenger, the terminal 130 may transmit the recognized information to the processor 160, and when recognizing the credit card, the terminal 130 may receive a boarding fare or an alighting fare via the communication with the server. According to an embodiment of the present disclosure, the terminal 130 may be attached to a rotatable member. When the vehicle is stopped and the vehicle door is opened, the terminal 130 may move from the inside of the vehicle to the outside by rotation of the rotatable member, so that the passenger may pay the boarding fare without boarding the vehicle. A more detailed description will be made with reference to FIG. 3.

FIG. 3 is a diagram schematically showing a terminal according to an embodiment of the present disclosure.

The terminal 130 may include a reading device 131 that may recognize the passenger card (e.g., the identification card or the credit card (the transportation card) of the passenger) and an output device 132 that provides payment information. In this regard, the passenger card may store unique information of the passenger (unique passenger information). The output device 132 may include a display device and a sound output device, and may provide the payment information visually and audibly. However, the present disclosure may not be limited thereto, and the terminal 130 may be implemented integrally with the vehicle, and may be attached to each of a vehicle inner surface and a vehicle outer surface in a form of a pad. Therefore, the passenger may tag the passenger card from the outside of the vehicle without boarding the vehicle.

The output device 140 may visually or audibly inform the passenger of boarding approval or boarding disapproval. According to an embodiment, the output device 140 may include lighting installed on a bottom of the vehicle door, and may output different colors based on the boarding approval or the boarding disapproval. According to an embodiment, the output device 140 may output a green light when the boarding approval is determined, and output a red light when the boarding disapproval is determined, so that the passenger may intuitively recognize the boarding approval or the boarding disapproval. In addition, the output device 140 may be implemented as a display equipped with a sound output device to output different images and messages based on the boarding approval or the boarding disapproval.

The storage 150 may store at least one algorithm for performing calculation or execution of various commands for an operation of the vehicle control device according to an embodiment of the present disclosure. In addition, the storage 150 may store information on a plurality of passengers. In this regard, the passenger information may include the unique information of the passenger (unique passenger information) provided in advance by the passenger. For example, the unique information of the passenger may include a unique number (an ID), identification card information, regular boarding payment information, payment method information, a phone number, and the like of the passenger. The storage 150 may include at least one storage medium among a flash memory, a hard disc, a memory card, a read-only memory (ROM), a random access memory (RAM), an electrically erasable programmable read-only memory (EEPROM), a programmable read-only memory (PROM), a magnetic memory, a magnetic disk, and an optical disk.

The processor 160 may be implemented by various processing devices such as a microprocessor having a built-in semiconductor chip capable of performing the calculation or the execution of the various commands, and may control the operation of the vehicle control device according to one embodiment of the present disclosure.

The processor 160 may control the position of the passenger to be obtained from the outside of the vehicle before the passenger boards the vehicle, may control whether a obtained passenger is approved to board the vehicle to be determined based on the information on the plurality of passengers stored in advance when it is determined based on the position of the passenger that a passenger closest to the vehicle door is obtained, and may control a boarding approval indication or a boarding disapproval indication to be output based on whether the boarding is approved. In addition, the processor 160 may control the position of the passenger to be obtained from the inside of the vehicle before the passenger alights from the vehicle, may control whether a obtained passenger is approved to alight from the vehicle to be determined based on the information on the plurality of passengers stored in advance when it is determined based on the position of the passenger that a passenger closest to the vehicle door is obtained, and may control an alighting approval indication or an alighting disapproval indication to be output based on whether the alighting is approved.

According to an embodiment, the processor 160 may obtain the face of the passenger using the first sensor, and may obtain the face of the passenger closest to the vehicle door using the first sensor and the second sensor.

The processor 160 may determine whether the face of the passenger closest to the vehicle door is obtained.

When determining that the face of the passenger or the face of the passenger closest to the vehicle door is not obtained, the processor 160 may accumulate the number of times the face of the passenger is not obtained, and may determine whether the number of times the face of the passenger is not obtained exceeds the predetermined number of times.

When determining that the number of times the face of the passenger is not obtained does not exceed the predetermined number of times, the processor 160 may make a request for face re-recognition and obtain the face of the passenger. On the other hand, when determining that the number of times the face of the passenger is not obtained exceeds the predetermined number of times, the processor 160 may request the passenger to tag the passenger card (the identification card or the credit card (the transportation card)) to the terminal 130. The processor 160 may determine the unique information of the passenger based on passenger card tagging information (identification card tagging information or credit card (transportation card) tagging information) of the passenger.

According to an embodiment, when determining that the face of the passenger closest to the vehicle door is obtained or that the passenger card tagging information (the identification card tagging information or the credit card tagging information) of the passenger is obtained, the processor 160 may determine the unique information of the passenger based on the information stored in the storage 150. According to an embodiment, the processor 160 may learn the information on the plurality of passengers stored in advance with artificial intelligence, and determine the unique information of the passenger (the passenger whose face is obtained or the passenger who tagged the passenger card (the identification card (the credit card))) based on the learned model. In addition, when the unique information (e.g., the regular boarding payment information and free boarding information) of the passenger is determined from the information on the plurality of passengers stored in advance, the processor 160 may approve the boarding (or the alighting) of the passenger.

According to another embodiment, when determining that the face of the passenger closest to the vehicle door is obtained or that the passenger card tagging information (the identification card tagging information or the credit card tagging information) of the passenger is obtained, the processor 160 may transmit the obtained passenger face image or the passenger card tagging information (the identification card information (or the credit card tagging information)) tagged by the passenger to the server 200 and request the server 200 to check the unique information of the passenger, and approve the boarding (or the alighting) of the passenger when the unique information of the passenger is determined in the server 200 and a passenger boarding (or alighting) approval message is received from the server 200.

According to another embodiment, when determining that the face of the passenger closest to the vehicle door is obtained or that the passenger card tagging information (the identification card tagging information or the credit card tagging information) of the passenger is obtained and that the unique information (the payment method information) of the passenger (the passenger whose face is obtained or the passenger who tagged the passenger card (the identification card (the credit card))) is determined from the information on the plurality of passengers stored in advance in the storage 150, the processor 160 may request the server 200 to receive the boarding fare, and approve the boarding of the passenger when receiving a payment approval message from the server 200.

According to another embodiment, when determining that the face of the passenger closest to the vehicle door is obtained or that the passenger card tagging information (the identification card tagging information or the credit card tagging information) of the passenger is obtained, the processor 160 may allow the obtained passenger face image or the passenger card tagging information (the identification card information (or the credit card tagging information)) tagged by the passenger to be transmitted to the server 200, and approve the boarding (or the alighting) of the passenger when receiving the payment approval message from the server 200 as the unique information of the passenger is determined in the server 200 and then the payment of the boarding fare is approved.

The processor 160 may control the output device 140 to output the boarding (or the alighting) approval indication or the boarding (or the alighting) disapproval indication based on whether the boarding (or the alighting) of the passenger is approved. According to an embodiment, the processor 160 may allow the output device 140 to output the green light when the boarding (or the alighting) approval is determined, and output the red light when the boarding (or the alighting) disapproval is determined, so that the passenger may intuitively recognize the boarding (or the alighting) approval or the boarding (or the alighting) disapproval. In addition, the processor 160 may output the different images and messages on the display equipped with the sound output device based on the boarding (or the alighting) approval or the boarding (or the alighting) disapproval.

When determining that the passenger has boarded the vehicle after outputting the boarding approval indication, the processor 160 may check the boarding and increase the number of passengers. When determining that the passenger has alighted from the vehicle after outputting the alighting approval indication, the processor 160 may check the alighting and count the number of passengers again. On the other hand, when determining that the passenger has boarded (or alighted from) the vehicle after outputting the boarding (or the alighting) disapproval indication, the processor 160 may report free boarding (free alighting) of the passenger to the server 200. The processor 160 may assign a temporary unique number to the passenger who has boarded (alighted from) the vehicle free.

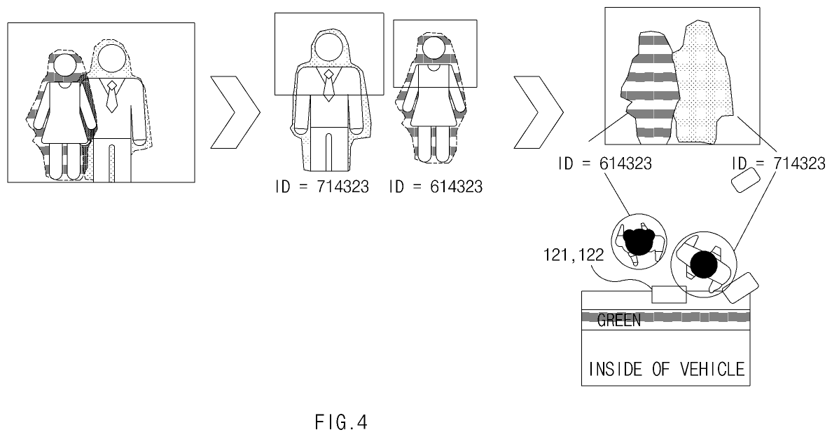

According to an embodiment, the processor 160 may determine the tagging information (the payment information) of the passenger card (the credit card (the transportation card)) via the terminal 130. When determining boarding (or alighting) of two or more passengers based on the tagging information (the payment information) of the passenger card (the credit card (the transportation card)) via the terminal 130, the processor 160 may obtain a first passenger closest to the terminal 130 and the rest of the passengers in an order of proximity to the first passenger. In addition, the processor 160 may approve the boarding (or the alighting) of the obtained two or more passengers. In addition, the processor 160 may output the boarding (or alighting) approval indication until the boarding of the obtained two or more passengers is completed, and may output the boarding (or the alighting) disapproval indication when the boarding (or the alighting) of the obtained two or more passengers is completed. A more detailed description will be made with reference to FIGS. 4 to 8.

FIGS. 4 to 8 are diagrams schematically showing an operation of a vehicle control device according to an embodiment of the present disclosure during boarding of a passenger.

As shown in FIG. 4, the processor 160 may obtain the positions of the passengers around the vehicle door based on the distances from the vehicle to the passengers using the second sensor. In addition, the processor 160 may obtain the faces of the passengers obtained using the first sensor, and determine the unique information (e.g., passenger unique numbers: 714323 and 614323) of the obtained passengers based on the information stored in advance in the storage 150 or the information received from the server 200. The processor 160 may match the unique information of the passenger with the passenger around the vehicle door.

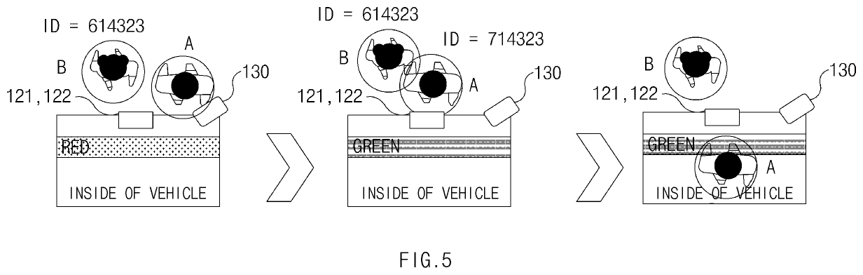

As shown in FIG. 5, when a passenger A and a passenger B are obtained, and unique information of the passenger A is not determined and unique information of the passenger B (e.g., the passenger unique number: 614323) is determined, the processor 160 may output the red light while informing that boarding of the passenger A, located closest to the vehicle door, is disapproved. Thereafter, the processor 160 may make a request for face re-recognition to the passenger A, and when a face of the passenger A is re-sensed, may determine unique information of the passenger A (e.g., the passenger unique number: 714323), and output the green light to inform that the boarding of the passenger A is approved. Thereafter, because the processor 160 has also determined the unique information of the passenger B, even after the boarding of the passenger A is completed, the processor 160 may output the green light to inform that the boarding of the passenger B is approved.

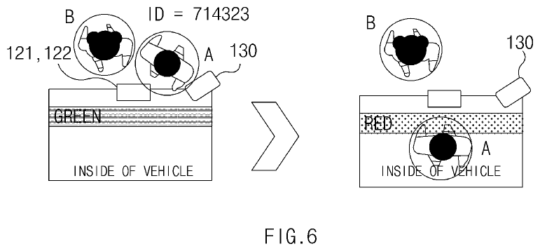

As shown in FIG. 6, when the passenger A and the passenger B are obtained, and the unique information of the passenger A (e.g., the passenger unique number: 714323) is determined and the unique information of passenger B is not determined, the processor 160 may output the green light to inform that the boarding of the passenger A is approved because the passenger A is positioned closest to the vehicle door. Thereafter, the processor 160 may output the red light while informing that the boarding of the passenger B is disapproved after the boarding of the passenger A is completed. Thereafter, the processor 160 may make a request for the face re-recognition to the passenger B.

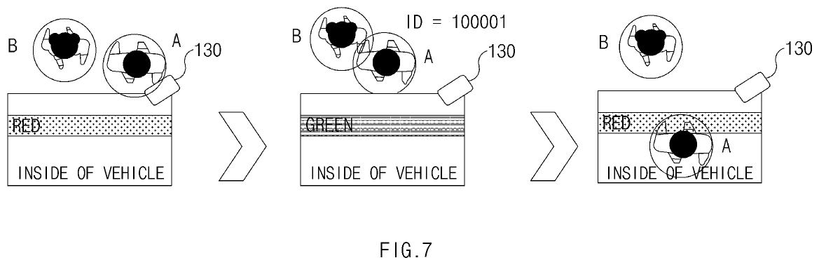

As shown in FIG. 7, when the passenger A and the passenger B are obtained, and the unique information of the passenger A and the passenger B are not determined, the processor 160 may output the red light to inform that the boarding is disapproved. Thereafter, when determining that the passenger A has tagged the passenger card (the credit card (the transportation card)), the processor 160 may assign the temporary unique number (e.g., 100001) to the passenger A, and output the green light to inform that the boarding is approved. The processor 160 may output the red light to inform that the boarding of the passenger B is disapproved after the boarding of the passenger A is completed.

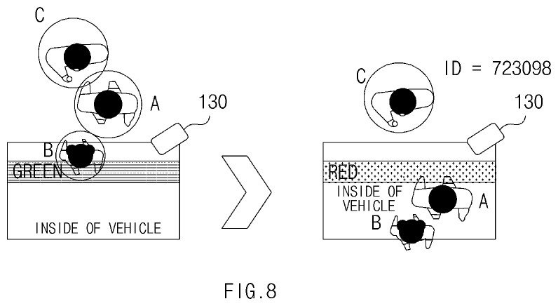

As shown in FIG. 8, when boarding of two passengers is determined based on the credit card payment information via the terminal 130, the processor 160 may obtain a first passenger (the passenger A) closest to terminal 130 and the passenger B closest to the first passenger (the passenger D). The processor 160 may approve the boarding of the obtained passenger, and output the green light to inform that the boarding of the obtained passenger is approved. The processor 160 may output the red light when the boarding of the obtained passenger A and passenger B is completed. Thereafter, the processor 160 may obtain a passenger C and determine unique information of the passenger C to determine whether to approve boarding of the passenger C.

The processor 160 may track the movement of the passenger within the vehicle by matching the passenger on board with the unique information of the passenger (the passenger unique number (or the temporary unique number assigned to the passenger)) when the passenger boards the vehicle, determine that the passenger has alighted from the vehicle when the passenger moves from a region around the door to the outside of the vehicle, and perform alighting processing by matching the passenger who has alighted from the vehicle with the unique information of the passenger (the passenger unique number (or the unique number assigned to the passenger)). In this regard, in a case of the passenger whose passenger unique number is determined at the time of boarding or the passenger who is assigned with the temporary unique number by boarding the vehicle by tagging the passenger card, the alighting processing may include requesting the server to receive the settled transportation fare during the alighting. In addition, in a case of the passenger assigned with the temporary unique number because of the free boarding, the alighting processing may include transmitting the image of the face of the passenger who has boarded the vehicle free or reporting the free alighting to the server.

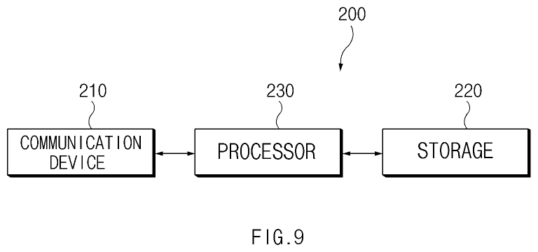

FIG. 9 is a diagram showing a configuration of the server 200 according to an embodiment of the present disclosure.

As shown in FIG. 9, the server 200 according to an embodiment of the present disclosure may include a communication device 210, storage 220, and a processor 230.

The server 200 may include the communication device 210, the storage 220, and the processor 230.

The communication device 210 may communicate with the vehicle control device 100 in various wireless communication schemes such as a Wi-Fi, a WiBro, a global system for mobile communication (GSM), a code division multiple access (CDMA), a wideband code division multiple access (WCDMA), a universal mobile telecommunication system (UMTS), a time division multiple access (TDMA), a long term evolution (LTE), and the like.

The storage 220 may store at least one algorithm for performing calculation or execution of various commands for an operation of the server according to an embodiment of the present disclosure. In addition, the storage 220 may store the information on the plurality of passengers. In this regard, the passenger information may include the unique information of the passenger (unique passenger information) provided in advance by the passenger. For example, the unique information of the passenger may include the passenger unique number, the identification card information, the regular boarding payment information, the payment method information, the phone number, and the like of the passenger. The storage 220 may include at least one storage medium among a flash memory, a hard disc, a memory card, a read-only memory (ROM), a random access memory (RAM), an electrically erasable programmable read-only memory (EEPROM), a programmable read-only memory (PROM), a magnetic memory, a magnetic disk, and an optical disk.

The processor 230 may be implemented by various processing devices such as a microprocessor having a built-in semiconductor chip capable of performing the calculation or the execution of the various commands, and may control the server 200 according to one embodiment of the present disclosure.

According to one embodiment, when receiving the obtained face image of the passenger from the vehicle control device 100 or receiving the passenger card tagging information (the identification card tagging information (or the credit card tagging information)) so as to receive the request for the unique information checking, the processor 230 may determine the unique information of the passenger based on the received information. According to an embodiment, when the information received from the vehicle control device 100 matches the information on the plurality of passengers stored in the storage 220, the processor 230 may determine the unique information of the passenger and transmit the passenger boarding (or alighting) approval message to the vehicle control device 100.

In addition, according to another embodiment, when the unique information of the passenger is determined, the processor 230 may automatically approve the payment of the boarding fare, and may transmit the payment approval message to the vehicle control device 100 when the payment is completed.

On the other hand, when the information received from the vehicle control device 100 does not match the information on the plurality of passengers stored in the storage 220, because the unique information of the passenger is not able to be determined, the processor 230 may transmit the passenger boarding (or alighting) disapproval message to the vehicle control device 100.

According to another embodiment, the processor 230 may perform the payment approval when receiving a request for the reception of the passenger's boarding fare from the vehicle control device 100. In addition, the processor 230 may transmit the payment approval message to the vehicle control device 100 when the payment approval is completed.

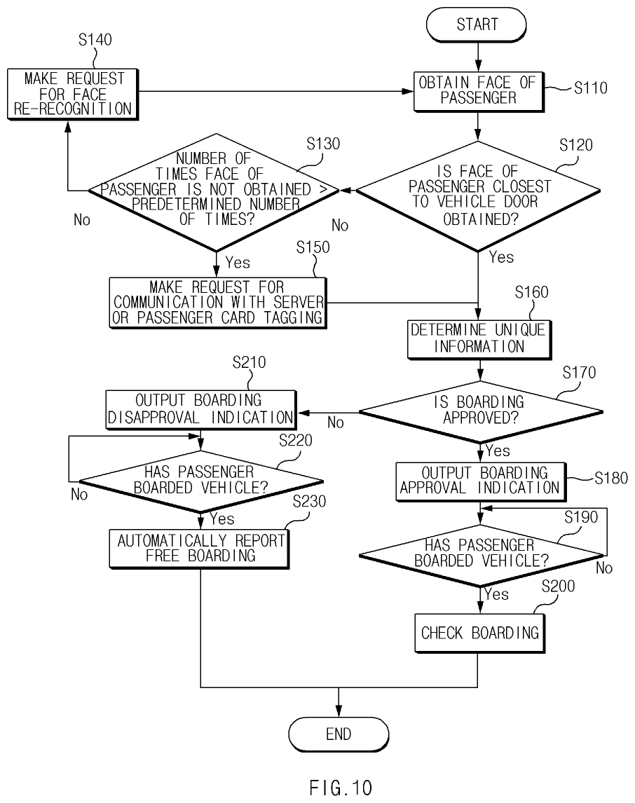

FIGS. 10 to 14 are diagrams showing a vehicle control method according to an embodiment of the present disclosure.

As shown in FIG. 10, according to an embodiment, the processor 160 may obtain the face of the passenger and the position of the passenger (S110). According to an embodiment, the processor 160 may obtain the face of the passenger using the first sensor, obtain the position of the passenger closest to the vehicle door using the first sensor and the second sensor, and obtain the face of the closest passenger.

The processor 160 may determine whether the face of the passenger closest to the vehicle door is obtained (S120).

According to an embodiment, when it is determined in S120 that the face of the passenger closest to the vehicle door is obtained (Yes), the processor 160 may learn the information on the plurality of passengers stored in advance in the storage 150 with the artificial intelligence, and determine the unique information of the passenger based on the learned model (S160). For example, the processor 160 may determine the unique information (e.g., the regular boarding payment information and the free boarding information) of the passenger whose face is obtained from the information on the plurality of passengers stored in advance.

According to an embodiment, when it is determined in S120 that the face of the passenger or the face of the passenger closest to the vehicle door is not obtained (No), the processor 160 may accumulate the number of times the face of the passenger is not obtained, and may determine whether the number of times the face of the passenger is not obtained exceeds the predetermined number of times (S130).

When it is determined in S130 that the number of times the face of the passenger is not obtained does not exceed the predetermined number of times (No), the processor 160 may make a request for face re-recognition (S140) and obtain the face of the passenger (S110).

On the other hand, when it is determined in S130 that the number of times the face of the passenger is not obtained exceeds the predetermined number of times (Yes), the processor 160 may request the passenger to tag the passenger card (the identification card or the credit card (the transportation card)) to the terminal 130 (S150).

The processor 160 may determine the unique information of the passenger based on the passenger card tagging information (the identification card tagging information or the credit card (the transportation card) tagging information) of the passenger (S160).

The processor 160 may determine whether the boarding of the passenger is approved based on the unique information of the passenger (S170). In S170, the processor 160 may determine that the boarding of the passenger is approved when the unique information of the passenger is determined.

According to an embodiment, when the boarding approval is determined in S170, the processor 160 may output the boarding approval indication (S180). In S180, the processor 160 may output the green light via the output device 140, or output a boarding approval image or message.

The processor 160 may determine whether the passenger has boarded the vehicle after outputting the boarding approval indication (S190). When it is determined in S190 that the passenger has boarded the vehicle (Yes), the processor 160 may check the boarding and increase the number of passengers (S200).

On the other hand, when the unique information of the passenger is not determined in S170, the processor 160 may determine that the boarding of the passenger is disapproved.

When it is determined in S170 that the boarding of the passenger is disapproved (No), the processor 160 may output the boarding disapproval indication (S210). In S210, the processor 160 may output the red light via the output device 140 or output a boarding disapproval image or message.

The processor 160 may determine whether the passenger has boarded the vehicle after outputting the boarding disapproval indication (S220). When determining that the passenger has boarded the vehicle (Yes), the processor 160 may report the free boarding of the passenger to the server 200 (S230).

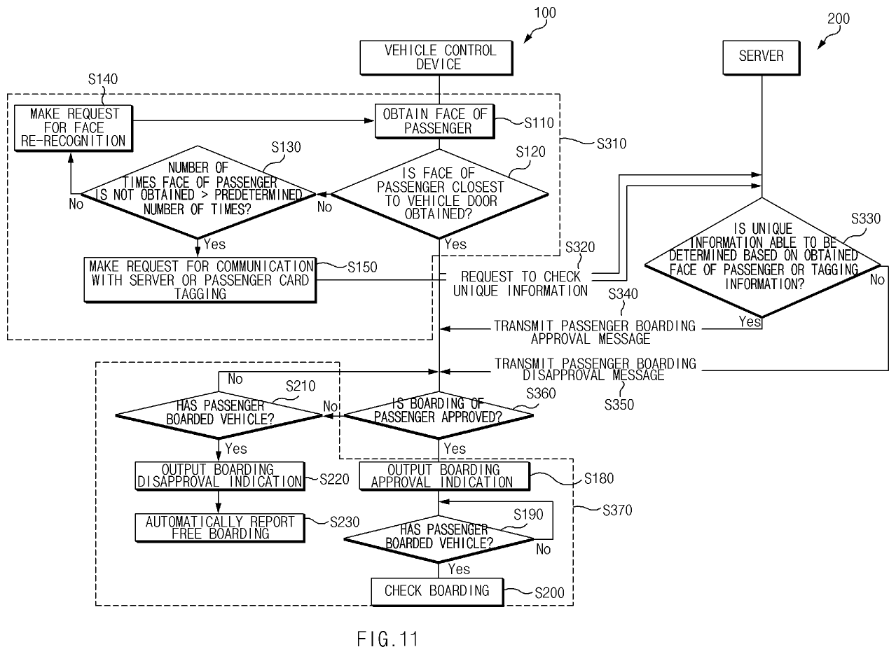

As shown in FIG. 11, the vehicle control device 100 may perform the operations from S110 to S150 in FIG. 10 (S310).

When the face of the passenger closest to the vehicle door is obtained and the passenger card tagging information (the identification card tagging information or the credit card (the transportation card) tagging information) of the passenger is obtained in S310, the vehicle control device 100 may transmit the obtained face image of the passenger or the passenger card tagging information (the identification card information (or the credit card tagging information)) tagged by the passenger to the server 200 and request the server 200 to check the unique information of the passenger (S320).

When receiving the obtained face image of the passenger from the vehicle control device 100 or receiving the passenger card tagging information (the identification card tagging information (or the credit card tagging information)) so as to receive the request for the unique information checking, the server 200 may determine whether the unique information of the passenger is able to be determined (S330).

According to one embodiment, in S330, when the information received from the vehicle control device 100 matches the information on the plurality of passengers stored in advance in the storage 220, the server 200 may determine that the unique information of the passenger is determined (Yes), and transmit the passenger boarding approval message to the vehicle control device 100 (S340).

On the other hand, when the information received from the vehicle control device 100 does not match the information on the plurality of passengers stored in advance in the storage 220 in S300, the server 200 may determine that the unique information of the passenger is not able to be determined (No), and may transmit the passenger boarding disapproval message to the vehicle control device 100 (S350).

The vehicle control device 100 may determine whether the boarding of the passenger is approved (S360). When receiving the passenger boarding approval message from the server 200 in S360, the vehicle control device 100 may determine that the boarding of the passenger is approved. In addition, when receiving the passenger boarding disapproval message from the server 200 in S360, the vehicle control device 100 may determine that the boarding of the passenger is disapproved.

Thereafter, the vehicle control device 100 may perform the operations from S180 to S230 in FIG. 10 (S370).

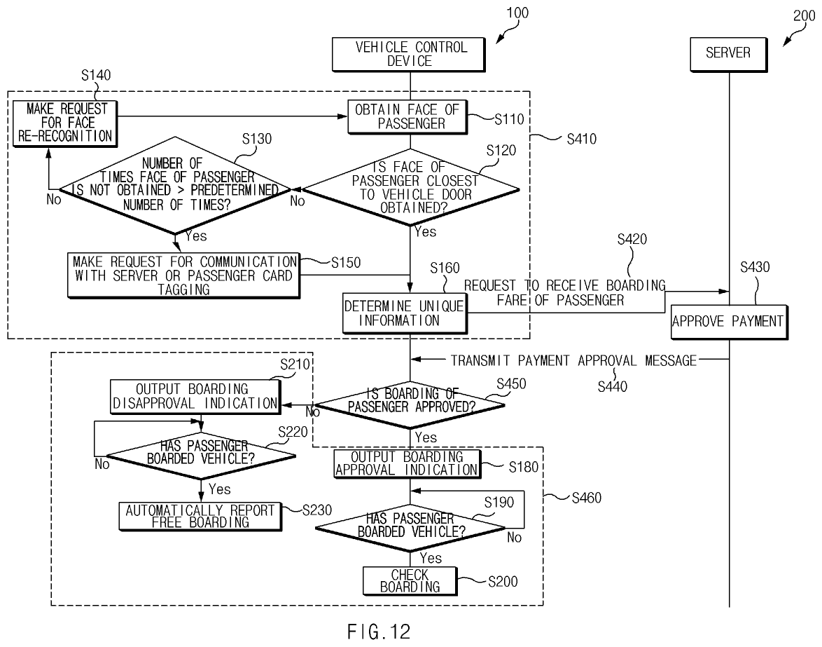

As shown in FIG. 12, the vehicle control device 100 may perform the operations from S110 to S160 in FIG. 10 (S410). In S160, the unique information of the passenger may include the payment method information.

When the unique information (the payment method information) of the passenger is determined, the vehicle control device 100 may request the server 200 to receive the boarding fare of the passenger (S420). When receiving the request for the reception of the boarding fare from the vehicle control device 100, the server 200 may approve the payment based on the payment method information of the passenger (S430), and transmit the payment approval message (S440).

The vehicle control device 100 may determine whether the boarding of the passenger is approved based on whether the payment approval message is received from the server 200 (S450). When it is determined in S450 that the payment approval message is received from the server 200 (Yes), the vehicle control device 100 may determine that the boarding of the passenger is approved. In addition, when it is determined in S450 that the payment approval message is not received from the server 200 (No) after the boarding fare reception request, the vehicle control device 100 may determine that passenger boarding is disapproved.

Thereafter, the vehicle control device 100 may perform the operations from S180 to S230 in FIG. 10 (S460).

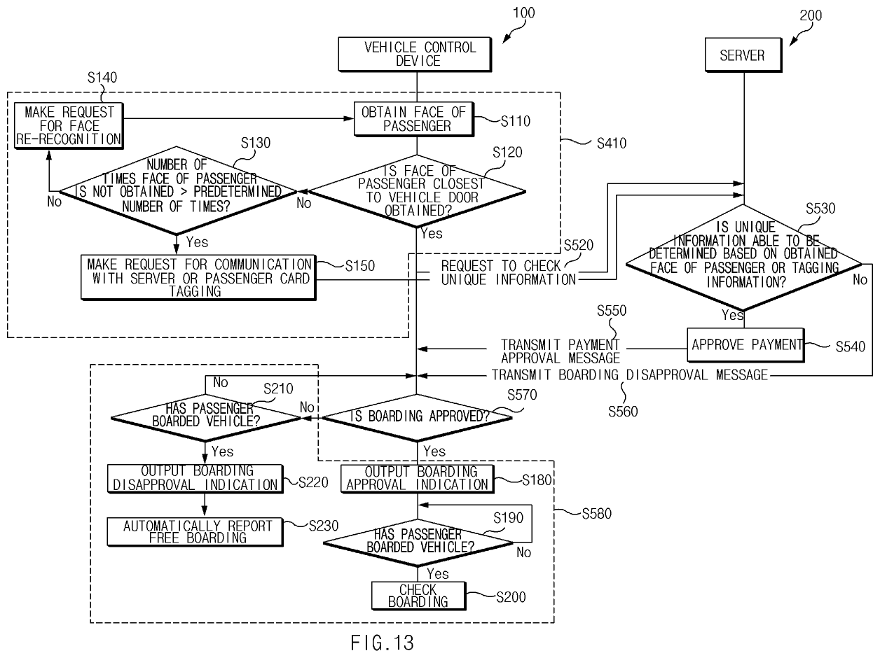

As shown in FIG. 13, the operations from S110 to S150 in FIG. 10 may be performed (S510).

When the face of the passenger closest to the vehicle door is obtained and the passenger card tagging information (the identification card tagging information or the credit card (the transportation card) tagging information) of the passenger is obtained in S510, the vehicle control device 100 may transmit the obtained face image of the passenger or the passenger card tagging information (the identification card information (or the credit card tagging information)) tagged by the passenger to the server 200 and request the server 200 to check the unique information of the passenger (S520).

When receiving the obtained face image of the passenger from the vehicle control device 100 or receiving the passenger card tagging information (the identification card tagging information (or the credit card tagging information)) so as to receive the request for the unique information checking, the server 200 may determine whether the unique information of the passenger is able to be determined (S530).

According to an embodiment, when the information received from the vehicle control device 100 matches with the information on the plurality of passengers stored in advance in the storage 220 in S530, the server 200 may determine that the unique information of the passenger is determined. In addition, when the boarding fare of the passenger must be paid, the server 200 may approve the payment of the boarding fare based on the unique information (the payment method information) (S540). In addition, when the payment of the boarding fare is approved, the server 200 may transmit the payment approval message to the vehicle control device 100 (S550).

On the other hand, when the information received from the vehicle control device 100 does not match with the information on the plurality of passengers stored in advance in the storage 220 in S530, the server 200 may determine that the unique information of the passenger is not determined, and transmit the boarding disapproval message to the vehicle control device 100 (S560).

The vehicle control device 100 may determine whether the boarding of the passenger is approved based on the received message (S570). When it is determined in S570 that the payment approval message has been received from the server 200, the vehicle control device 100 may determine that the boarding of the passenger is approved. In addition, when receiving the boarding disapproval message from the server 200 in S570, the vehicle control device 100 may determine that the boarding of the passenger is disapproved.

Thereafter, the vehicle control device 100 may perform the operations from S180 to S230 in FIG. 10 (S580).

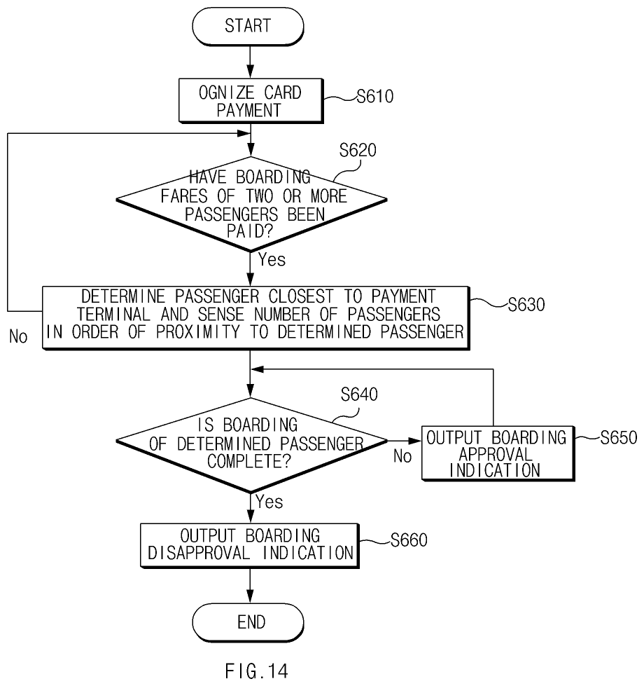

As shown in FIG. 14, the vehicle control device 100 may recognize the tagging (the payment) of the passenger card (the credit card (the transportation card)) via the terminal 130 (S610). The vehicle control device 100 may determine whether the boarding fares of the two or more passengers have been paid based on the tagging information (the payment information) (S620).

When it is determined in S620 that the boarding fares of the two or more passengers have been paid (Yes), the vehicle control device 100 may obtain the first passenger closest to the terminal 130 and the rest of the passengers in the order of the proximity to the first passenger (S630).

The vehicle control device 100 may approve the boarding of the obtained passenger and may determine whether the boarding is complete (S640). When it is determined in S640 that the boarding of the obtained passenger is not completed, the vehicle control device 100 may output the boarding approval indication until it is determined that the boarding of the obtained passenger is completed (S650).

The vehicle control device 100 may output the boarding disapproval indication when the boarding of the obtained passenger is completed (S660).

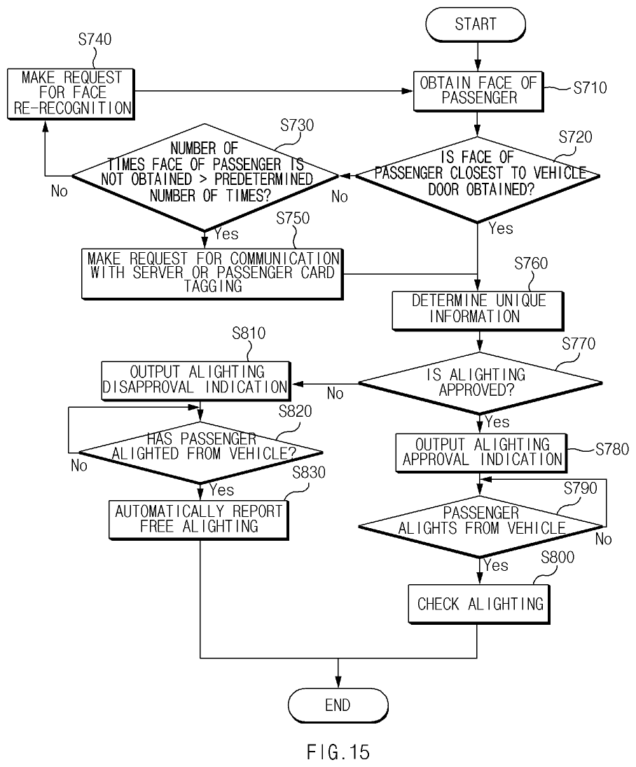

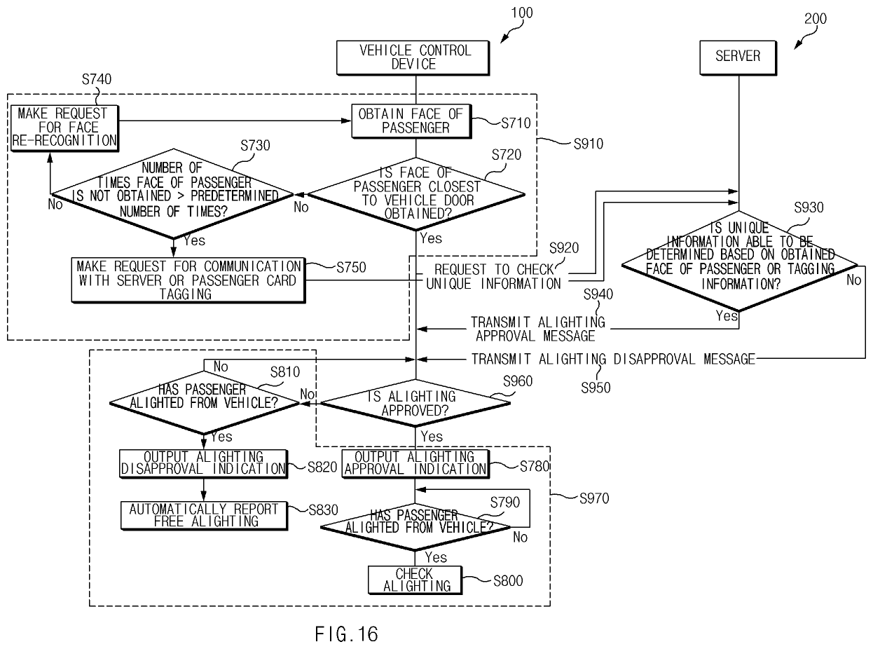

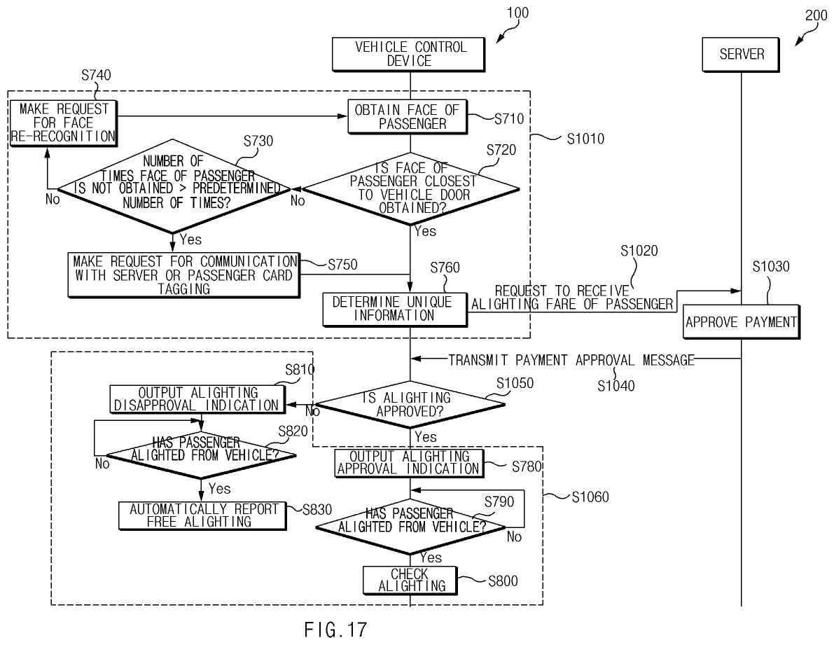

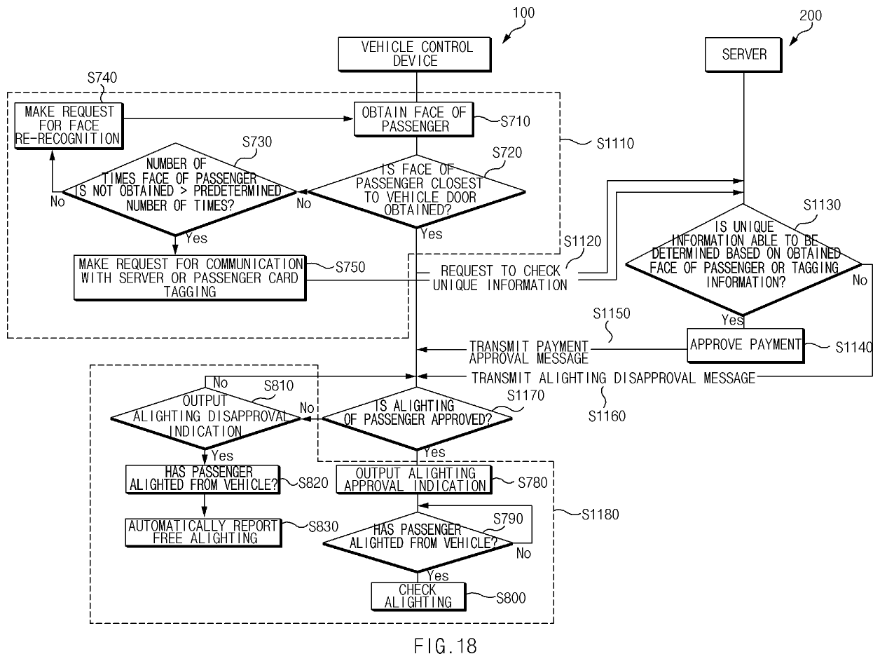

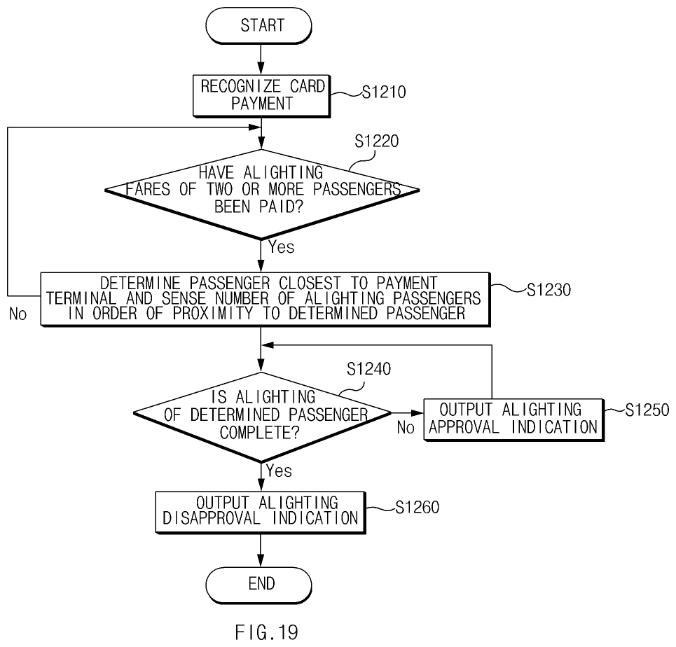

According to another embodiment of the present disclosure, when the passenger inside the vehicle closest to the vehicle door is obtained after the passengers board the vehicle, the vehicle control device 100 may control whether the alighting of the obtained passenger is approved to be determined based on the information on the plurality of passengers stored in advance, and control the alighting approval indication or the alighting disapproval indication to be output based on whether the alighting is approved. For the operation of the vehicle control device 100 for determining whether the alighting is approved and outputting the alighting approval indication or the alighting disapproval indication based on whether the alighting is approved according to another embodiment of the present disclosure, refer to FIGS. 15 to 19.

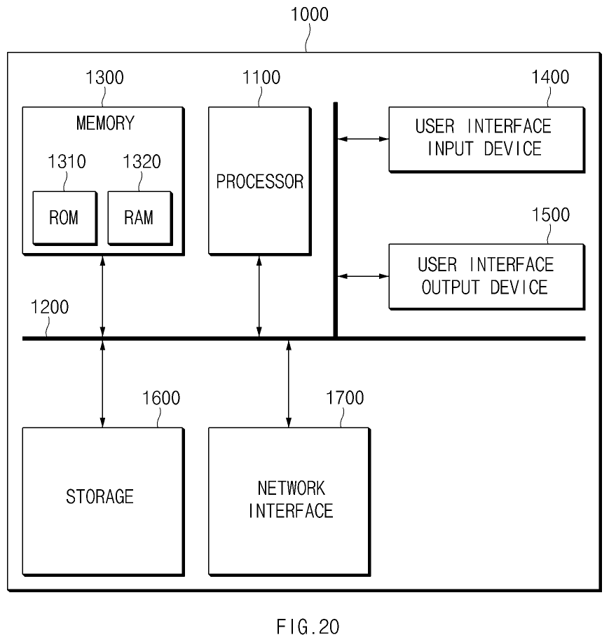

The operations from S710 to 51260 in FIGS. 15 to 19 are replaced with the description of the operations from FIGS. 10 to 14 after replacing the word of the boarding described in the operations from S110 to S660 in FIGS. 10 to 14 with the ‘alighting’ and applying the ‘alighting’. FIG. 20 is a diagram illustrating a configuration of a computing system executing a method according to an embodiment of the present disclosure.

Referring to FIG. 20, a computing system 1000 may include at least one processor 1100, a memory 1300, a user interface input device 1400, a user interface output device 1500, storage 1600, and a network interface 1700 connected via a bus 1200.

The processor 1100 may be a central processing unit (CPU) or a semiconductor device that performs processing on commands stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM. The exemplary storage medium is coupled to the processor 1100, which may read information from, and write information to, the storage medium. In another method, the storage medium may be integral with the processor 1100. The processor and the storage medium may reside within an application specific integrated circuit (ASIC). The ASIC may reside within the user terminal. In another method, the processor and the storage medium may reside as individual components in the user terminal.

The description above is merely illustrative of the technical idea of the present disclosure, and various modifications and changes may be made by those skilled in the art without departing from the essential characteristics of the present disclosure.

Therefore, the embodiments disclosed in the present disclosure are not intended to limit the technical idea of the present disclosure but to illustrate the present disclosure, and the scope of the technical idea of the present disclosure is not limited by the embodiments. The scope of the present disclosure should be construed as being covered by the scope of the appended claims, and all technical ideas falling within the scope of the claims should be construed as being included in the scope of the present disclosure.

The device and the method for controlling the vehicle according to one embodiment of the present disclosure may periodically identify the number of passengers and provide the convenient payment method during the boarding and the alighting of the passengers to prevent the overload of the high-occupancy autonomous vehicle.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A device configured to control a vehicle, the device comprising:
a sensor configured to obtain unique passenger data from a plurality of potential passengers of a vehicle, the data including facial information of each potential passenger and/or a position of each potential passenger;
a memory storage configured to store, in advance of a boarding of the vehicle process, unique passenger information associated with the plurality of potential passengers; and
a processor configured to:
determine whether to approve boarding of a respective passenger having a position closest to the vehicle based on the unique passenger information stored in the memory storage; and
control either one of: a boarding approval indication or a boarding disapproval indication to be output based on whether boarding of the respective passenger is approved.

2. The device of claim 1, wherein the processor is further configured to:
obtain the facial information of the respective passenger from the sensor; and
determine that the boarding of the respective passenger is approved based on a comparison of the obtained facial information of the respective passenger and the unique passenger information stored in the memory storage.

3. The device of claim 1, wherein:
unique passenger information associated with the plurality of potential passengers comprises unique passenger card tagging information; and
wherein the processor is configured to:
obtain passenger card tagging information associated with the plurality of potential passengers; and
determine that boarding of the passenger providing the passenger card tagging information is approved if the passenger card tagging information associated with the plurality of potential passengers matches the unique passenger card tagging information stored in the memory storage.

4. The device of claim 3, wherein the processor is further configured to:
transmit an image of the facial information of the respective passenger and/or the passenger card tagging information associated with the plurality of potential passengers to a server;
receive a passenger boarding approval message from the server based on the transmitted image and/or the transmitted passenger card tagging information; and
determine that the boarding of the respective passenger and/or the passenger providing the passenger card tagging information is approved based on the passenger boarding approval message received from the server.

5. The device of claim 2, wherein the processor is further configured to:
request a server to receive payment for a boarding fare if the unique passenger information of the respective passenger is determined based on unique passenger information associated with the plurality of potential passengers;
receive a payment approval message from the server if payment for the boarding fare is approved by the server; and
determine that the boarding of the passenger is approved based on the payment approval message from the server.

6. The device of claim 2, wherein the processor is further configured to:
receive a payment approval message from a server if payment of a boarding fare is approved by the server; and
determine that the boarding of the passenger is approved if the payment approval message is received from the server.

7. The device of claim 1, further comprising:
a terminal capable of recognizing a passenger card of the passenger.

8. The device of claim 7, wherein the terminal is configured to move from the inside of the vehicle to the outside of the vehicle if a door of the vehicle is opened.

9. The device of claim 7, wherein the processor is further configured to:
obtain unique passenger data associated with a first passenger closest to the terminal; and
obtain unique passenger data associated with the remaining passengers of the plurality of potential passengers based on a proximity to the first passenger.

10. The device of claim 9, wherein the processor is further configured to determine that boarding of the remaining passengers of the plurality of potential passengers is approved.

11. The device of claim 10, wherein the processor is further configured to output a respective boarding approval indication for each passenger until boarding of the remaining passengers is completed.

12. The device of claim 1, wherein the processor is further configured to:
learn the unique passenger information with artificial intelligence and generate a learned model; and
determine unique passenger information associated with potential passenger based on the learned model.

13. The device of claim 1, wherein the processor is further configured to:
track a movement of a moving passenger inside of the vehicle by matching unique passenger information associated with the moving passenger;
determine that the moving passenger has alighted from the vehicle if the moving passenger moves from the inside of the vehicle to outside of the vehicle; and
perform alighting processing by matching the moving passenger who has alighted from the vehicle with the unique passenger information associated with the moving passenger.

14. A device configured to control a vehicle, the device comprising:
a sensor configured to obtain unique passenger data from a plurality of potential passengers of a vehicle, the data including facial information of each potential passenger and a position of each potential passenger;
a memory storage configured to store, in advance of a boarding of the vehicle process, unique passenger information associated with the plurality of potential passengers; and
a processor configured to:
determine whether to approve alighting of a respective passenger based on the unique passenger information stored in the memory storage; and
control either one of: an alighting approval indication or an alighting disapproval indication to be output based on whether alighting of the respective passenger is approved.

15. The device of claim 14, wherein the processor is further configured to:
obtain the facial information of the respective passenger from the sensor; and
determine that the alighting of the passenger is approved based on a comparison of the obtained facial information of the respective passenger and the unique passenger information stored in the memory storage.

16. The device of claim 14, wherein:
unique passenger information associated with the plurality of potential passengers comprises unique passenger card tagging information; and
wherein the processor is further configured to:
obtain passenger card tagging information associated with the plurality of potential passengers; and
determine that alighting of the passenger providing the passenger card tagging information is approved if the passenger card tagging information associated with the plurality of potential passengers matches the unique passenger card tagging information stored in the memory storage.

17. The device of claim 16, wherein the processor is configured to:
transmit an image of facial information of the respective passenger and/or the passenger card tagging information associated with the plurality of potential passengers to a server;
receive a passenger alighting approval message from the server based on the transmitted image and/or the transmitted passenger card tagging information; and
determine that the alighting of the respective passenger and/or the passenger providing the passenger card tagging information is approved based on the passenger alighting approval message received from the server.

18. The device of claim 15, wherein the processor is further configured to:
request a server to receive payment for an alighting fare if the unique passenger information of the respective passenger is determined based on unique passenger information associated with the plurality of potential passengers;
receive a payment approval message from the server if payment for the alighting fare is approved by the server; and
determine that the alighting of the passenger is approved based on the payment approval message from the server.

19. The device of claim 15, wherein the processor is configured to:
receive a payment approval message from a server if payment of an alighting fare is approved by the server and the alighting of the respective passenger is approved based on the comparison of the obtained facial information of the respective passenger and the unique passenger information stored in the memory storage; and
determine that the alighting of the passenger is approved if the payment approval message is received from the server.

20. A method for controlling boarding and alighting of a vehicle, the method comprising:
obtaining unique passenger data from a plurality of potential passengers of a vehicle, the data including facial information of each potential passenger and/or a position of each potential passenger;
storing, in advance of a boarding process and/or an alighting process of the vehicle, unique passenger information associated with the plurality of potential passengers;
determining whether to approve boarding or alighting of a respective passenger having a position closest to the vehicle based on the unique passenger information stored in the memory storage; and
controlling either one of: a boarding approval indication or a boarding disapproval indication to be output based on whether boarding of the respective passenger is approved; and
controlling either one of: an alighting approval indication or an alighting disapproval indication to be output based on whether the alighting of the respective passenger is approved.
